(19) United States
(12) Patent Application Publication
(10) Pub. No.: US 2005/0224545 A1
(43) Pub. Date: Oct. 13, 2005

(54) Inflatable observation tower and method for erecting an inflatable observation tower

(76) Inventor: James H. Boschma JR., Huntsville, AL (US)

Correspondence Address: NEIL K. NYDEGGER;NYDEGGER & ASSOCIATES, 348 Olive Street, San Diego, CA, 92103, US

(21) Appl. No.: 11/009,696

(22) Filed: Dec. 10, 2004

Related U.S. Application Data
(63) Continuation-in-part of application No. 10/736,453, filed on Dec. 15, 2003.

(51) Int. Cl. B60R 9/00

(52) U.S. Cl. 224/403

(57) ABSTRACT

An inflatable tower system for establishing an elevated observation platform includes an elongated, inflatable cloth envelope having first and second ends. A blower is provided to introduce air into the cloth envelope at the first envelope end and an observation device, such as a video camera, is mounted on the envelope at the second envelope end. A tension line is attached to the envelope near the second envelope end and disposed in the inflation volume created by the envelope. The tension line exits the envelope near the envelope's first end and is attached to a tension control mechanism to allow the envelope to be inflated from a compact, spiral shape. With this compact shape, the deployment apparatus, including the deflated envelope, fits within and can be deployed from the bed of a pickup truck.

This application is a continuation-in-part of application Ser. No. 10/736,453, filed Dec. 15, 2003, which is currently pending. The contents of application Ser. No. 10/736,453 are incorporated herein by reference.

### FIELD OF THE INVENTION

The present invention pertains generally to cold air inflatable structures and methods for erecting inflatable structures. More particularly, the present invention pertains to inflatable towers. The present invention is particularly, but not exclusively, useful as an inflatable tower for establishing an elevated observation platform.

### BACKGROUND OF THE INVENTION

It is often desirable to loft an electronic payload to a stable, elevated position and maintain the payload at an elevated position for an extended period of time. Typical electronic payloads can include, but are not necessarily limited to sensors, including chemical, radiological and biological sensors, communications antennas and relay equipment, electronic jamming devices, observation devices such as cameras and radars, and other devices that can take advantage of an elevated position. Typical applications of such electronic devices include telecommunications, electronic warfare, imagery collection, scientific study, television operations, atmospheric testing to detect a hazardous release or weapon detonation, and perhaps most importantly, wide area surveillance. More recently, there has been an increased demand to provide temporary, rapidly deployable, wide area surveillance for the purpose of security in both military and civilian environments.

Many of these applications require an elevated platform to be established quickly, with little notice, and without regard to weather conditions. In addition, for some (if not all) of the above-described applications including wide area surveillance, it is sometimes desirable to loft relatively heavy payloads (e.g. payloads weighing 100 pounds or more) to relatively high elevations (e.g. elevations of 100 feet or more). In all cases, it is desirable to quickly deliver an electronic payload to a pre-selected location and thereafter loft the payload rapidly and with minimal personnel requirements.

One factor that must be considered when contemplating the lofting of relatively large payloads to relatively high elevations is wind. Specifically, wind can be a concern during payload lofting, and in addition, once the payload has reached the desired elevated position, at which time it is generally desirable to maintain the payload as stationary as possible. Indeed, such systems are often required to remain operational at wind speeds of 35 knots or more and survive wind speeds or 50 knots or more without damage. Moreover, higher wind speeds are typically experienced at higher payload elevations.

In light of the above, it is an object of the present invention to provide systems and methods for lofting relatively heavy electronic payloads to substantially stationary positions at relatively high elevations. It is another object of the present invention to provide inflatable structures and methods for erecting inflatable structures capable of quickly lofting an electronic payload with minimal personnel. Yet another object of the present invention is to provide inflatable structures and methods for erecting inflatable structures which can remain operable in strong winds and survive even larger wind gusts. It is another object of the present invention to provide inflatable structures and erecting methods which allow the inflatable structure and deployment apparatus to be easily transported to the deployment site using a light-duty truck. Still another object of the present invention is to provide systems and methods for lofting a relatively heavy electronic payload which are easy to use, relatively simple to implement, and comparatively cost effective.

### SUMMARY OF THE INVENTION

The present invention is directed to an inflatable tower system for establishing an elevated observation platform. To establish the platform, the system includes an elongated inflatable envelope. Typically, the envelope is made of a nylon cloth material and is substantially shaped as a truncated cone when fully inflated. With this shape, the elongated envelope extends from a first, relatively large diameter envelope end at the base of the cone to a second, relatively small diameter envelope end.

For the present invention, the system includes a blower for introducing air into the cloth envelope at the first envelope end. During inflation, the first envelope end is maintained at a fixed position relative to a ground location. For example, the first envelope end can be staked, weighted or simply attached to the blower which is then maintained stationary. Also for the inflatable tower system, an observation device, such as a video camera (or portions thereof), is mounted on the envelope at the second envelope end. The system can further include a hardwired or wireless communication link for transmitting electronic data between the observation device and a ground location.

In one particular embodiment of the system, a plurality of guy wires are attached to the envelope to hold the envelope during inflation and after the envelope has been fully inflated. Typically, this includes a pair of upper guy wires that are staked to the ground and attached to the envelope at the second envelop end, and a pair of intermediate guy wires that are staked to the ground and attached to the envelope between (e.g. midway between) the first and second envelope ends.

In another aspect of the present invention, a method is provided for erecting an inflatable tower to establish an elevated observation platform. For this method, an observation device (e.g. video camera) is first mounted on the cloth envelope at the second envelope end. The envelope is then folded to establish creases at one or more locations between the first and second envelope ends. Next, air is introduced (i.e. blown) into the envelope at the first envelope end to inflate a portion of the envelope between the first envelope end and the first crease. During this inflation, the second envelope end is restrained relative to the first envelope end, for example, by holding one of the upper guy wires. Once the portion of the envelope between the crease and the first envelope end is substantially inflated and oriented vertically, the second envelope end is slowly released (by releasing the upper guy wire) to unfold the crease while simultaneously introducing additional air into the envelope. This additional air inflates the portion of the envelop between the crease and the second envelope end to elevate the second end (and the observation device) relative to the first envelope end. Inflation is then continued until the entire elongated envelope is oriented vertically.

In another embodiment of the present invention, a portable, inflatable tower system is provided for rapidly delivering an electronic device to a pre-selected location and lofting the electronic device at the location. For this embodiment, the system includes a vehicle, such as a pickup truck, and an elongated, inflatable envelope that extends from a first envelope end to a second envelope end. The first envelope end is attached to the vehicle and an electronic device is mounted on the envelope at the second envelope end.

In one implementation, the envelope is mounted on a stage while the envelope is in a deflated configuration. This stage is then positioned in the bed of the pickup truck and secured to the sidewalls of the truck bed using one or more load lock jacks. A cold air blower is provided for introducing air into the first envelope end to inflate the envelope and loft the electronic device. In some cases, an inverter that is electrically connected to the DC power circuit of the vehicle can be used to power a 115 VAC cold air blower. The system can further include a plurality of guy wires, with each guy wire having a first guy wire end that is attached to the envelope near the second envelope end and a second guy wire end that is attached to the corner points of the pickup using expanding blocks.

In another aspect of the present invention, the envelope surrounds and defines an inflation volume. A tension line (e.g. rope) is then disposed in the inflation volume and attached to the envelope at or near the second envelope end. One end of the tension line exits the envelope near the envelope's first end and is attached to a tensioning mechanism, such as a wench or a braking pulley. Prior to inflation, the envelope can be rolled into a compact, spiral shape, wherein the second envelope end is located at the small radius end of the spiral and the first envelope end is located at the large radius end of the spiral. With this cooperation of structure, the envelope can be inflated from the compact, spiral configuration by introducing air into the envelope at the envelope's first end while simultaneously maintaining tension in the tension line. Inflation from the spiral configuration causes the envelope to inflate from the bottom to the top in a relatively small space.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of an inflatable tower system shown in a fully inflated state and with a portion cut away to show envelope thickness;

FIGS. 2A-D are a series of sequential perspective views illustrating a method for erecting the inflatable tower system;

FIG. 3 is an exploded, perspective view of an inflatable tower system configured for deployment from the bed of a pickup truck, shown with a portion of the envelope removed to reveal the inflation volume and internal tension line;

FIG. 4 is a front, plan view showing the inflatable envelope of the system of FIG. 3, in a partially inflated state; and

FIG. 5 shows the system of FIG. 3 with the inflatable envelope in the fully inflated state.

### DESCRIPTION OF THE PREFERRED EMBODIMENTS

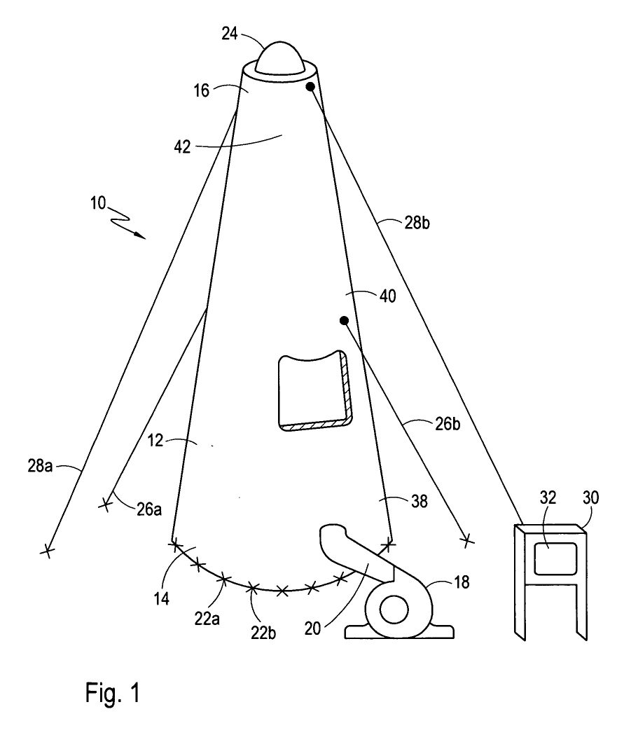

Referring to FIG. 1, an inflatable tower system for establishing an elevated observation platform is shown and generally designated 10. As shown in FIG. 1, the system 10 includes an envelope 12 that is typically made of nylon cloth or another suitable material which is strong, lightweight and capable of holding an inflation fluid. For the embodiment shown in FIG. 1, the envelope 12 is substantially shaped as a truncated cone when fully inflated. Specifically, the elongated envelope 12 extends from a first, relatively large diameter envelope end 14 at the base of the cone to a second, relatively small diameter envelope end 16.

Continuing with FIG. 1, it can be seen that the system 10 includes a blower 18 for delivering air through a nylon duct 20 and into the cloth envelope 12 at the first envelope end 14. Also shown in FIG. 1, the first envelope end 14 is maintained at a fixed position relative to a ground location using stakes, of which exemplary stakes 22a and 22b have been labeled. Alternatively, the first envelope end 14 can be weighted or simply attached to the blower 18, which is then maintained stationary.

For the system 10, an electronic device 24, such as a video camera (or portions thereof), is mounted on the envelope 12 at the second envelope end 16. For the system 10, the electronic device 24 can include but is not limited to one or more sensors, communications antennas and relay equipment, electronic jamming devices, observation devices such as cameras and radars, and other devices that can take advantage of an elevated position. In addition to the electronic device 24, one or more lights, which can be indicator/warning lights, search lights or flood lights can be mounted on the envelope 12 at the second envelope end 16.

It can further be seen that the system 10 shown in FIG. 1 includes a pair of intermediate guy wires 26a,b and a pair of upper guy wires 28a,b to hold the envelope 12 during inflation and after the envelope 12 has been fully inflated. As shown, each intermediate guy wire 26a,b is secured (e.g. staked) to the ground and attached to the envelope 12 between (e.g. midway between) the first envelope end 14 and the second envelope end 16. Also shown, the upper guy wires 28a,b are attached to the envelope 12 at the second envelope end 16. For the system 10, the upper guy wire 28b can also function as a communication link for transmitting electronic data between the elevated electronic device 24 and a ground station 30. The communication link between the electronic device 24 and a ground station 30 can include conductors (i.e. wires or coaxial cable), one or more fiber optic cable(s), wireless links or a combination thereof. The ground station 30 can include provisions for data input/output including but not limited to displays (such as display 32 shown), a keyboard (not shown), etc.

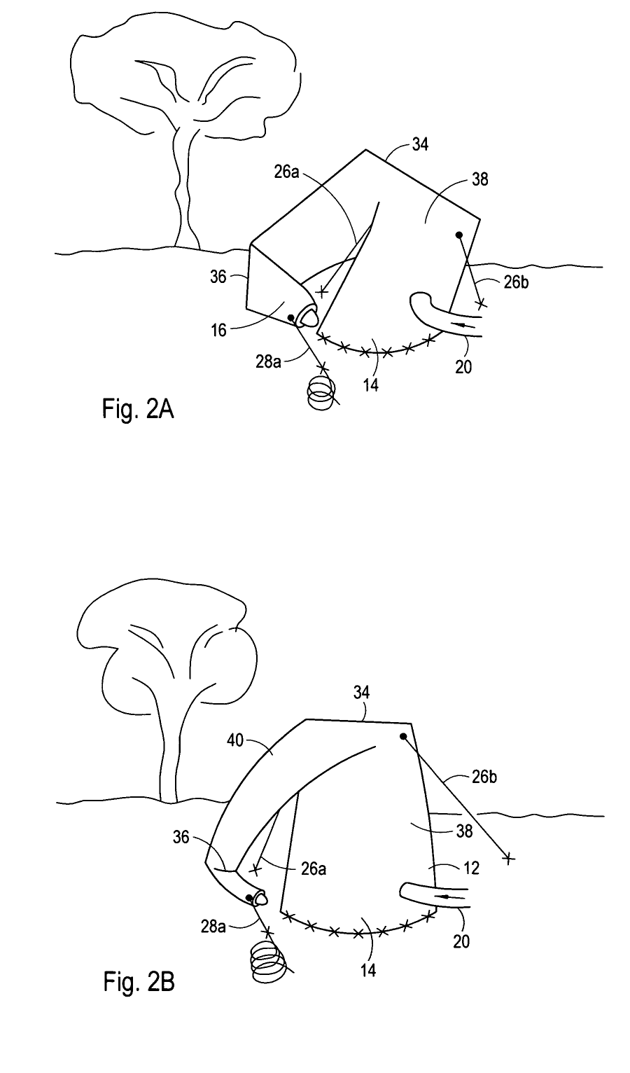

A method for erecting the inflatable tower system 10 show in FIG. 1 is illustrated in FIGS. 2A-2D. For this method, the electronic device 24 (e.g. video camera) is first mounted on the cloth envelope 12 at the second envelope end 16. As illustrated in FIG. 2A, the envelope 12 is then folded to establish creases, such as the crease 34 and crease 36 shown. Theses creases 34, 36 are established at locations between the first envelope end 14 and the second envelope end 16, and preferably as shown, the crease 34 is established to interpose the attachment location of the intermediate guy wires 26a,b between the crease 34 and first envelope end 14.

Once the creases 34, 36 have been established, air is then introduced (i.e. blown) into the envelope 12 at the first envelope end 14 to inflate the portion 38 of the envelope 12 between the first envelope end 14 and the first crease 34. During this inflation, the second envelope end 16 is restrained relative to the first envelope end 14, for example, by holding the upper guy wire 28a. Due to the crease 34, the portion 38 of the envelope 12 is the first part of the envelope 12 to inflate and, upon inflation, the portion 38 becomes oriented vertically, as shown in FIG. 2B. At this point, the intermediate guy wires 26a,b can be secured to the ground to hold the envelope 12 and maintain the portion 38 oriented vertically.

Once the portion 38 has been substantially inflated and is oriented vertically, the upper guy wire 28a (which was held during inflation of the portion 38) is slowly released and additional air is blown into the envelope 12 through the first envelope end 14. The slow release of the second envelope end 16 while simultaneously introducing additional air into the first envelope end 14 causes the crease 34 to slowly unfold allowing air to inflate the portion 40 of the envelope 12 between the crease 34 and the crease 36, as shown in FIG. 2C. Eventually, with the continued introduction of air and further release of the upper guy wire 28a, the portion 40 becomes substantially inflated and oriented vertically, as shown in FIG. 2D. This process is continued (i.e. continued introduction of air and further release of the upper guy wire 28a) until the portion 42 between the crease 36 and second envelope end 16 becomes substantially inflated and oriented vertically, as shown in FIG. 1. At this point, the upper guy wires 28a,b can be secured to the ground and the electronic device 24 activated.

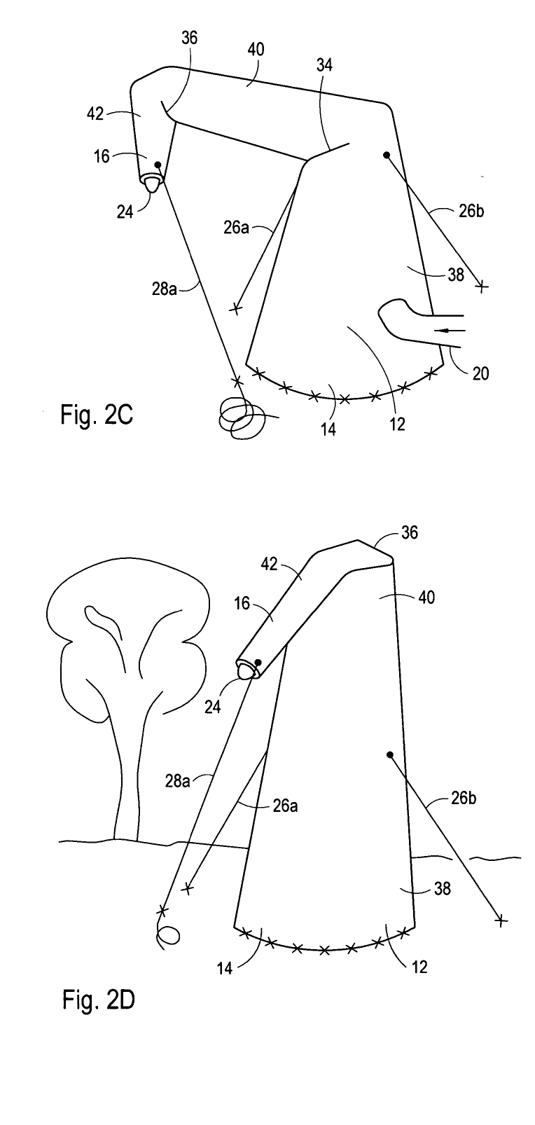

FIG. 3 illustrates a portable inflatable tower system, generally designated 10′, that is provided for rapidly delivering an electronic device 24′ (e.g. a video camera) to a pre-selected location and lofting the electronic device 24′ at the location. As shown, the system 10′ includes a vehicle 44, which in this case is a pickup truck, and an inflatable envelope 12′ that extends from a first envelope end 14′ to a second envelope end 16′. FIG. 3 shows the envelope 12′ in a deflated state, and illustrates that for the system 10′, the envelope 12′ can be configured into a compact, spiral shaped configuration. In this spiral shaped configuration, the second envelope end 16′ is located at the small radius end of the spiral and the first envelope end 14′ is located at the large radius end of the spiral. Also shown, the electronic device 24′ is mounted on the envelope 12′ at the second envelope end 16′.

Continuing with FIG. 3, it can be seen that the system 10′ further includes a stage 46 and a plurality of load lock jacks 48a,b. As the exploded view illustrates, the first end 14′ of the envelope 12′ is attached to the stage 46. The stage 46, in turn, is disposed in the bed of the vehicle 44 and secured to the sidewalls 50 of the bed using the load lock jacks 48a,b. A cold air blower 18′ is mounted in the bed of the vehicle 44 below the stage 46. When activated, the blower can be used to introduce air into the envelope 12′ to inflate the envelope 12′ and loft the electronic device 24′. For the system 10, an inverter 52 that is electrically connected to the DC power circuit of the vehicle 44 provides 115 VAC power to the blower 18′. A valve 54, which is typically a flapper valve, is sealed between the blower 18′ and the envelope 12′ to prevent air from flowing out of the envelope 12′ once the envelope 12′ has been inflated. As shown, a hole 56 is formed in the stage 46 to allow air flowing from the blower 18′ to pass through the valve and reach the envelope 12′.

FIG. 3 illustrates that the envelope 12′ surrounds and defines an internal inflation volume 57. As shown in FIG. 3, for the system 10′, a tension line 58, which for the embodiment shown is a rope, is partially disposed in the inflation volume 57 and attached to the envelope 12′ at or near the second envelope end 16′. Also shown, one end of the tension line 58 exits the envelope 12′ near the envelope's first end 14′ and is attached to a tensioning mechanism 60, which is typically a wench or braking pulley. Functionally, the tension mechanism 60 is capable of reeling out and drawing in the tension line 58 while maintaining a pre-selected tension on the tension line 58. The pre-selected tension applied to the tension line 58, while the tension line 58 is reeled out or drawn in, can be variable, constant or controlled within a pre-selected range.

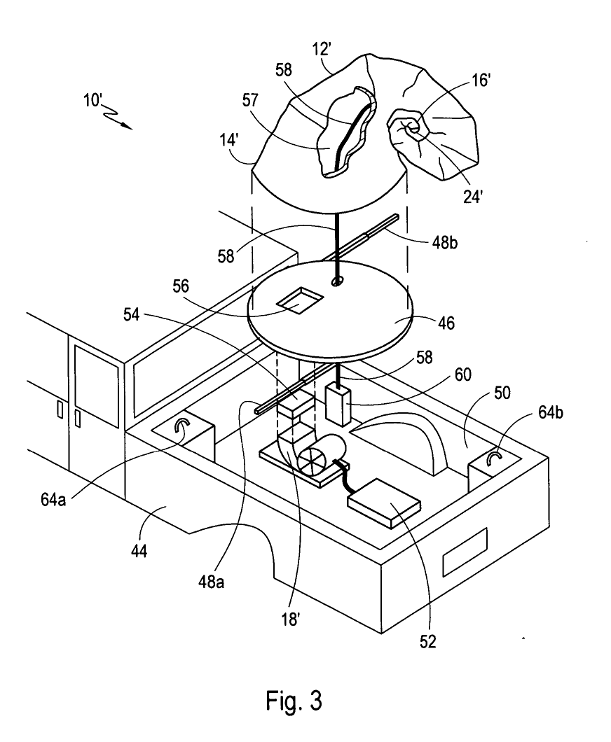

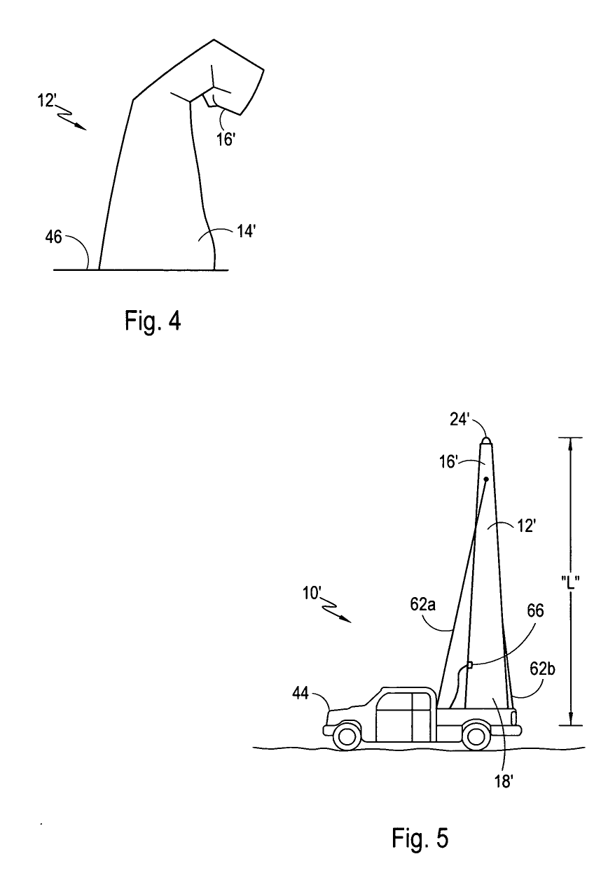

The operation of the system 10′ can best be appreciated with cross-reference to FIGS. 3, 4 and 5 which illustrate the envelope 12′ in various states of inflation. Specifically, FIG. 3 shows the envelope 12′ in a deflated state, FIG. 4 shows the envelope 12′ in a partially inflated state and FIG. 5 shows the envelope 12′ in a fully inflated state. As indicated above and shown in FIG. 3, the envelope 12′ is inflated from a compact, spiral configuration by introducing air into the envelope 12′ at the envelope's first end 14′ using the blower 18′. During inflation, the tension line 58 is reeled out from the tensioning mechanism 60, and as indicated above, a pre-selected tension is maintained in the tension line 58. As shown in FIG. 4, during initial inflation, the portion of the envelope 12′ near the first end 14′ inflates first while the portion of the envelope 12′ near the second end 16′ remains “coiled” in a spiral shape. Comparing FIGS. 3, 4 and 5, it can be seen that upon further inflation, the envelope 12′ inflates upward from the bottom, with the portion of the envelope 12′ near the second end 16′ remaining in a somewhat spiral shape.

FIG. 5 shows the system 10′ after the envelope 12′ has been fully inflated. It is contemplated for the system 10′ that the envelope 12′ can have a length “L” between its first end 14′ (see FIG. 3) and second end 16′ that is greater than thirty feet and can be used to loft an electronic device 24′ having a weight greater than 100 pounds. FIG. 5 shows that the system 10′ includes a plurality of guy wires 62a,b for stabilizing the inflated envelope 12′. Cross referencing FIG. 5 with FIG. 3, it can be seen that each guy wire 62a,b has a guy wire end that is attached to the envelope 12′ near the second envelope end 16′ and a guy wire end that can be attached to a respective expanding block 64a,b that is positioned at a respective corner point of the vehicle 44, as shown. FIG. 5 also shows that the system 10′ can include a pressure switch 66 for measuring the pressure in the inflation volume 57 (see FIG. 3). The pressure switch 66 can be used to 1) shut down the blower 18′ when an adequate pressure has been obtained in the envelope 12′ and 2) activate the blower 18′ when the pressure inside the envelope 12′ drops below a pre-selected pressure.

After temporary deployment at a first location, the portable inflatable tower system 10′ can be used to quickly deflate the envelope 12′ and redeploy the electronic device 24′ at another location. Specifically, with the valve 54 open, the tensioning mechanism 60 can be used to draw in the tension line 58. With a portion of the tension line 58 disposed in the inflation volume 57, the retraction of the tension line 58 causes the envelope to curl upon deflation into the compact, spiral shaped configuration shown in FIG. 3. With this compact configuration, the vehicle 44 can be used to quickly move envelope 12′ to a new location for deployment of the electronic device 24′.

While the particular inflatable observation tower and method for erecting an inflatable observation tower as herein shown and disclosed in detail are fully capable of obtaining the objects and providing the advantages herein before stated, it is to be understood that they are merely illustrative of the presently preferred embodiments of the invention and that no limitations are intended to the details of construction or design herein shown other than as described in the appended claims.

1. A portable inflatable tower system for rapidly delivering an electronic device to a pre-selected location and lofting the electronic device at the location, said system comprising:
a vehicle;
an elongated inflatable envelope extending from a first envelope end to a second envelope end;
a means for attaching said first envelope end to said vehicle;
a means for inflating said envelope to elevate said second envelope end relative to said vehicle; and
an electronic device mounted on said envelope at said second envelope end.

2. A system as recited in claim 1 wherein said inflating means comprises a cold air blower attached to said vehicle.

3. A system as recited in claim 2 wherein said inflating means comprises an inverter electrically connected to said vehicle for powering said cold air blower.

4. A system as recited in claim 1 wherein said electronic device comprises a video camera.

5. A system as recited in claim 1 further comprising a plurality of guy wires, each guy wire having a first end attached to said envelope and a second end attached to said vehicle.

6. A system as recited in claim 1 wherein said envelope surrounds an inflation volume and said system further comprises:
a tension line having a first end attached to said second envelope end, said tension line extending from said second envelope end, through said inflation volume to a second tension line end; and
a means attached to said vehicle for maintaining a pre-selected, nonzero tension on said tension line during an inflation of said envelope.

7. A system as recited in claim 6 wherein said maintaining means comprises a wench attached to said second end of said tension line.

8. A system as recited in claim 6 wherein said maintaining means comprises a braking pulley attached to said second end of said tension line.

9. A system as recited in claim 1 wherein said inflatable envelope has a length between said first envelope end and said second envelope end, with said length being greater than thirty feet, and wherein said vehicle is a pickup truck.

10. A system as recited in claim 9 wherein said pickup truck is formed with a truck bed surrounded by sidewalls and said attachment means comprises:
a stage having said inflatable envelope mounted thereon, said stage positionable in said bed of said truck; and
a plurality of load lock jacks for securing said stage to said sidewalls.

11. A system as recited in claim 1 wherein said envelope is substantially shaped as a truncated cone when inflated.

12. A method for erecting an inflatable tower to establish an elevated observation platform, said method comprising the steps of:
providing an elongated envelope having a first end and a second end, said envelope surrounding an inflation volume;
securing a first end of a tension line to said second envelope end, said tension line extending through said inflation volume and having a second end located outside said envelope;
mounting an observation device on said envelope at said second end;
configuring said envelope into a substantially spiral shape; and thereafter
introducing air into said envelope at said first envelope end while simultaneously maintaining a nonzero tension in said tension line to inflate said envelope and loft said electronic device.

13. A method as recited in claim 12 wherein said first envelope end is attached to a vehicle during said introducing step.

14. A method as recited in claim 12 wherein said vehicle is a pickup truck.

15. A method as recited in claim 12 wherein said spiral has a small radius end and a large radius end and said first envelope end is located at said small radius end after said configuring step.

16. A method as recited in claim 12 wherein said observation device is a video camera for producing an electronic video image and said method further comprises the step of establishing a communications link for transmitting said video image to a ground location.

17. A method for rapidly delivering an electronic device to a pre-selected location and lofting the electronic device at the location, said method comprising the steps of:
providing an elongated envelope having a first end and a second end;
attaching said first end of said envelope to a vehicle;
mounting an electronic device onto said envelope at said second envelope end;
driving said vehicle to the pre-selected location; and
inflating said envelope to elevate said second envelope end relative to said vehicle and loft said electronic device.

18. A method as recited in claim 17 wherein said envelope surrounds an inflation volume and said method further comprises the steps of:
securing a first end of a tension line to said second envelope end, said tension line extending through said inflation volume and having a second end located outside said envelope;
configuring said envelope into a substantially spiral shape; and
maintaining a nonzero tension in said tension line during at least a portion of said inflation step.

19. A method as recited in claim 17 wherein said inflatable envelope has a length between said first envelope end and said second envelope end, with said length being greater than thirty feet, and wherein said vehicle is a pickup truck.

20. A method as recited in claim 19 wherein said pickup truck is formed with a truck bed surrounded by sidewalls and said attachment step comprises:
positioning a container in said bed of said truck for holding the inflatable envelope in a deflated state; and
securing said container to said sidewalls using a plurality of load lock jacks.
